(19) United States
(12) Patent Application Publication
(10) Pub. No.: US 2024/0025445 A1
(43) Pub. Date: Jan. 25, 2024

(54) SAFETY ENHANCED PLANNING SYSTEM WITH ANOMALY DETECTION FOR AUTONOMOUS VEHICLES

(71) Applicant: Baidu USA LLC, Sunnyvale, CA (US)

(72) Inventors: SHU JIANG, Sunnyvale, CA (US); SZUHAO WU, Sunnyvale, CA (US); HAO LIU, Sunnyvale, CA (US); YU CAO, Sunnyvale, CA (US); WEIMAN LIN, Sunnyvale, CA (US); HELEN K. PAN, Sunnyvale, CA (US)

(21) Appl. No.: 17/870,742

(22) Filed: Jul. 21, 2022

(51) Int. Cl. B60W 60/00; G06N 3/08

(52) U.S. Cl. CPC B60W 60/0015; G06N 3/08; B60W 2554/4041; B60W 2556/40

(57) ABSTRACT

A system perceives an environment of an autonomous driving vehicle (ADV) based on a plurality of sensors and map data. The system determines an obstacle in the perceived environment to be a moving vehicle and the moving vehicle is to a left lane, to a right lane, or in front of the ADV. The system performs an inference on the obstacle using a neural network model to determine whether a behavior of the obstacle is anomalous. The system determines the obstacle is anomalous based on the performed inference.

### TECHNICAL FIELD

Embodiments of the present disclosure relate generally to operating autonomous driving vehicles. More particularly, embodiments of the disclosure relate to a safety enhanced planning system with anomaly detection for autonomous vehicles.

### BACKGROUND

Vehicles operating in an autonomous mode (e.g., driverless) can relieve occupants, especially the driver, from some driving-related responsibilities. When operating in an autonomous mode, the vehicle can navigate to various locations using onboard sensors, allowing the vehicle to travel with minimal human interaction or in some cases without any passengers.

Motion planning and control are critical operations in autonomous driving. However, conventional motion planning operations estimate the difficulty of completing a given path mainly from its curvature and speed, without considering the differences in features for different types of vehicles. Same motion planning and control is applied to all types of vehicles, which may not be accurate and smooth under some circumstances.

In real world driving scenarios, there are a few “bad” drivers whose behavior is different from normal drivers. The “bad” drivers and their vehicles can be identified as high risk to surrounding vehicles. When a vehicle on the road is identified as high risk, a driver may choose to change lane or to keep a safe distance to the unsafe vehicle.

### BRIEF DESCRIPTION OF THE DRAWINGS

Embodiments of the disclosure are illustrated by way of example and not limitation in the figures of the accompanying drawings in which like references indicate similar elements.

FIG. 1 is a block diagram illustrating a networked system according to one embodiment.

FIG. 2 is a block diagram illustrating an example of an autonomous driving vehicle according to one embodiment.

FIGS. 3A-3B are block diagrams illustrating an example of an autonomous driving system used with an autonomous driving vehicle according to one embodiment.

FIG. 4 is a block diagram illustrating an example of an anomaly module according to one embodiment.

FIG. 5 is a block diagram illustrating an example of a pipelined neural network model according to one embodiment.

FIG. 6 is a block diagram illustrating an example of an environment encoder according to one embodiment.

FIG. 7 is a block diagram illustrating an example of a perceived driving environment in a vectorized representation according to one embodiment.

FIG. 8 is a block diagram illustrating an example of an obstacle trajectory encoder according to one embodiment.

FIG. 9 is a block diagram illustrating an example of a conditional variational autoencoder (CVAE) according to one embodiment.

FIG. 10 is a flow diagram illustrating a method to detect anomalous obstacles according to one embodiment.

### DETAILED DESCRIPTION

Various embodiments and aspects of the disclosures will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosures.

Reference in the specification to “one embodiment” or “an embodiment” means that a particular feature, structure, or characteristic described in conjunction with the embodiment can be included in at least one embodiment of the disclosure. The appearances of the phrase “in one embodiment” in various places in the specification do not necessarily all refer to the same embodiment.

According to some embodiments, an anomaly detection module of an autonomous driving vehicle (ADV) perceives a surrounding driving environment and identifies a neighboring vehicle to be anomalous for erratic driving behaviors using one or more neural network models.

Currently, autonomous driving vehicles (ADV) detect moving obstacles by types and keeps a safe distance from the moving obstacles accordingly. The general assumption is that ADVs have to take into account all types of driving behaviors but “bad” (or unexpected or anomalous) driving behaviors are not categorically identified. Bad drivers, whose behavior is different from normal driving behavior, introduces a high risk for surrounding vehicles.

Embodiments proposes a learning-based method to detect unsafe anomalous driving behavior of surrounding vehicles and plans a driving trajectory accordingly to avoid these unsafe vehicles. This detection and avoidance of unsafe vehicles in-turn enhances the safety of autonomous driving vehicles.

According to one embodiment, a system perceives an environment of an autonomous driving vehicle (ADV) based on a plurality of sensors and map data. The system determines an obstacle in the perceived environment to be a moving vehicle and the moving vehicle is to a left lane, to a right lane, or in front of the ADV. The system performs an inference on the obstacle using a neural network model to determine whether a behavior of the obstacle is anomalous. The system determines the obstacle is anomalous based on the performed inference.

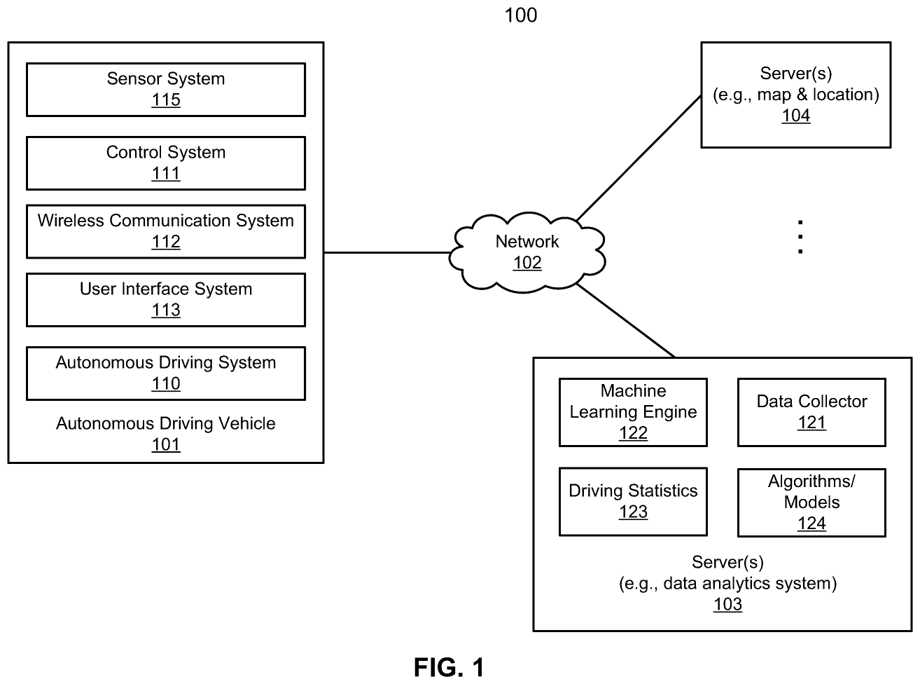

FIG. 1 is a block diagram illustrating an autonomous driving network configuration according to one embodiment of the disclosure. Referring to FIG. 1, network configuration 100 includes autonomous driving vehicle (ADV) 101 that may be communicatively coupled to one or more servers 103-104 over a network 102. Although there is one ADV shown, multiple ADVs can be coupled to each other and/or coupled to servers 103-104 over network 102. Network 102 may be any type of networks such as a local area network (LAN), a wide area network (WAN) such as the Internet, a cellular network, a satellite network, or a combination thereof, wired or wireless. Server(s) 103-104 may be any kind of servers or a cluster of servers, such as Web or cloud servers, application servers, backend servers, or a combination thereof. Servers 103-104 may be data analytics servers, content servers, traffic information servers, map and point of interest (MPOI) servers, or location servers, etc.

An ADV refers to a vehicle that can be configured to in an autonomous mode in which the vehicle navigates through an environment with little or no input from a driver. Such an ADV can include a sensor system having one or more sensors that are configured to detect information about the environment in which the vehicle operates. The vehicle and its associated controller(s) use the detected information to navigate through the environment. ADV 101 can operate in a manual mode, a full autonomous mode, or a partial autonomous mode.

In one embodiment, ADV 101 includes, but is not limited to, autonomous driving system (ADS) 110, vehicle control system 111, wireless communication system 112, user interface system 113, and sensor system 115. ADV 101 may further include certain common components included in ordinary vehicles, such as, an engine, wheels, steering wheel, transmission, etc., which may be controlled by vehicle control system 111 and/or ADS 110 using a variety of communication signals and/or commands, such as, for example, acceleration signals or commands, deceleration signals or commands, steering signals or commands, braking signals or commands, etc.

Components 110-115 may be communicatively coupled to each other via an interconnect, a bus, a network, or a combination thereof. For example, components 110-115 may be communicatively coupled to each other via a controller area network (CAN) bus. A CAN bus is a vehicle bus standard designed to allow microcontrollers and devices to communicate with each other in applications without a host computer. It is a message-based protocol, designed originally for multiplex electrical wiring within automobiles, but is also used in many other contexts.

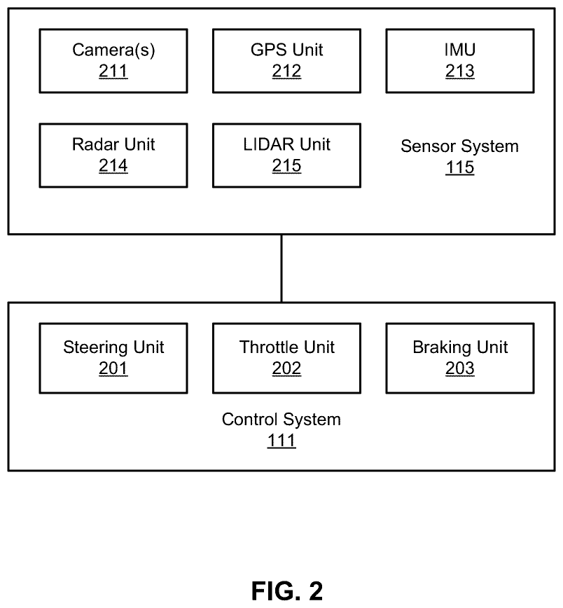

Referring now to FIG. 2, in one embodiment, sensor system 115 includes, but it is not limited to, one or more cameras 211, global positioning system (GPS) unit 212, inertial measurement unit (IMU) 213, radar unit 214, and a light detection and range (LIDAR) unit 215. GPS system 212 may include a transceiver operable to provide information regarding the position of the ADV. IMU unit 213 may sense position and orientation changes of the ADV based on inertial acceleration. Radar unit 214 may represent a system that utilizes radio signals to sense objects within the local environment of the ADV. In some embodiments, in addition to sensing objects, radar unit 214 may additionally sense the speed and/or heading of the objects. LIDAR unit 215 may sense objects in the environment in which the ADV is located using lasers. LIDAR unit 215 could include one or more laser sources, a laser scanner, and one or more detectors, among other system components. Cameras 211 may include one or more devices to capture images of the environment surrounding the ADV. Cameras 211 may be still cameras and/or video cameras. A camera may be mechanically movable, for example, by mounting the camera on a rotating and/or tilting a platform.

Sensor system 115 may further include other sensors, such as, a sonar sensor, an infrared sensor, a steering sensor, a throttle sensor, a braking sensor, and an audio sensor (e.g., microphone). An audio sensor may be configured to capture sound from the environment surrounding the ADV. A steering sensor may be configured to sense the steering angle of a steering wheel, wheels of the vehicle, or a combination thereof. A throttle sensor and a braking sensor sense the throttle position and braking position of the vehicle, respectively. In some situations, a throttle sensor and a braking sensor may be integrated as an integrated throttle/braking sensor.

In one embodiment, vehicle control system 111 includes, but is not limited to, steering unit 201, throttle unit 202 (also referred to as an acceleration unit), and braking unit 203. Steering unit 201 is to adjust the direction or heading of the vehicle. Throttle unit 202 is to control the speed of the motor or engine that in turn controls the speed and acceleration of the vehicle. Braking unit 203 is to decelerate the vehicle by providing friction to slow the wheels or tires of the vehicle. Note that the components as shown in FIG. 2 may be implemented in hardware, software, or a combination thereof.

Referring back to FIG. 1, wireless communication system 112 is to allow communication between ADV 101 and external systems, such as devices, sensors, other vehicles, etc. For example, wireless communication system 112 can wirelessly communicate with one or more devices directly or via a communication network, such as servers 103-104 over network 102. Wireless communication system 112 can use any cellular communication network or a wireless local area network (WLAN), e.g., using WiFi to communicate with another component or system. Wireless communication system 112 could communicate directly with a device (e.g., a mobile device of a passenger, a display device, a speaker within vehicle 101), for example, using an infrared link, Bluetooth, etc. User interface system 113 may be part of peripheral devices implemented within vehicle 101 including, for example, a keyboard, a touch screen display device, a microphone, and a speaker, etc.

Some or all of the functions of ADV 101 may be controlled or managed by ADS 110, especially when operating in an autonomous driving mode. ADS 110 includes the necessary hardware (e.g., processor(s), memory, storage) and software (e.g., operating system, planning and routing programs) to receive information from sensor system 115, control system 111, wireless communication system 112, and/or user interface system 113, process the received information, plan a route or path from a starting point to a destination point, and then drive vehicle 101 based on the planning and control information. Alternatively, ADS 110 may be integrated with vehicle control system 111.

For example, a user as a passenger may specify a starting location and a destination of a trip, for example, via a user interface. ADS 110 obtains the trip related data. For example, ADS 110 may obtain location and route data from an MPOI server, which may be a part of servers 103-104. The location server provides location services and the MPOI server provides map services and the POIs of certain locations. Alternatively, such location and MPOI information may be cached locally in a persistent storage device of ADS 110.

While ADV 101 is moving along the route, ADS 110 may also obtain real-time traffic information from a traffic information system or server (TIS). Note that servers 103-104 may be operated by a third party entity. Alternatively, the functionalities of servers 103-104 may be integrated with ADS 110. Based on the real-time traffic information, MPOI information, and location information, as well as real-time local environment data detected or sensed by sensor system 115 (e.g., obstacles, objects, nearby vehicles), ADS 110 can plan an optimal route and drive vehicle 101, for example, via control system 111, according to the planned route to reach the specified destination safely and efficiently.

Server 103 may be a data analytics system to perform data analytics services for a variety of clients. In one embodiment, data analytics system 103 includes data collector 121 and machine learning engine 122. Data collector 121 collects driving statistics 123 from a variety of vehicles, either ADVs or regular vehicles driven by human drivers. Driving statistics 123 include information indicating the driving commands (e.g., throttle, brake, steering commands) issued and responses of the vehicles (e.g., speeds, accelerations, decelerations, directions) captured by sensors of the vehicles at different points in time. Driving statistics 123 may further include information describing the driving environments at different points in time, such as, for example, routes (including starting and destination locations), MPOIs, road conditions, weather conditions, etc.

Based on driving statistics 123, machine learning engine 122 generates or trains a set of rules, algorithms, and/or predictive models 124 for a variety of purposes. In one embodiment, algorithms 124 may include a pipelined neural network model. The pipelined neural network model can include a combination of conditional variational autoencoder with an environment encoder and a trajectory encoder for obstacle trajectories. The pipelined neural network model can be trained offline and the trained pipelined neural network model is uploaded to the ADV for the ADV to perform inference using the pipelined neural network in real-time.

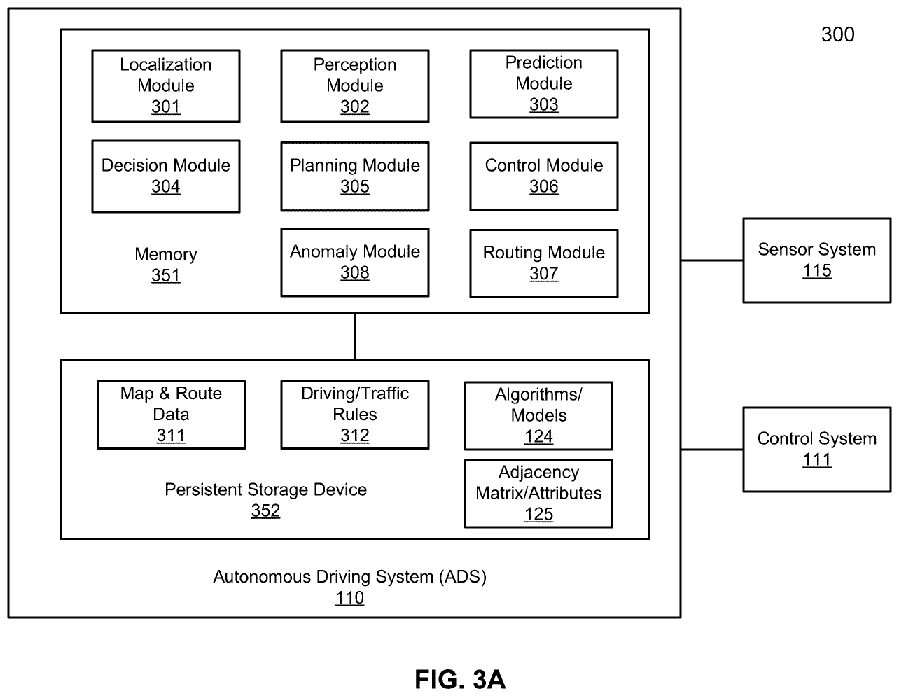

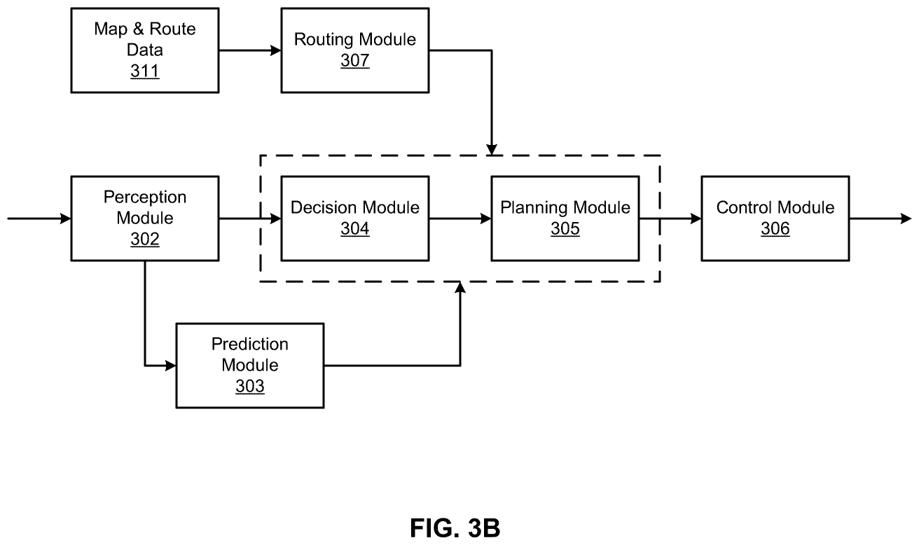

FIGS. 3A and 3B are block diagrams illustrating an example of an autonomous driving system used with an ADV according to one embodiment. System 300 may be implemented as a part of ADV 101 of FIG. 1 including, but is not limited to, ADS 110, control system 111, and sensor system 115. Referring to FIGS. 3A-3B, ADS 110 includes, but is not limited to, localization module 301, perception module 302, prediction module 303, decision module 304, planning module 305, control module 306, routing module 307, and anomaly module 308.

Some or all of modules 301-308 may be implemented in software, hardware, or a combination thereof. For example, these modules may be installed in persistent storage device 352, loaded into memory 351, and executed by one or more processors (not shown). Note that some or all of these modules may be communicatively coupled to or integrated with some or all modules of vehicle control system 111 of FIG. 2. Some of modules 301-308 may be integrated together as an integrated module.

Localization module 301 determines a current location of ADV 300 (e.g., leveraging GPS unit 212) and manages any data related to a trip or route of a user. Localization module 301 (also referred to as a map and route module) manages any data related to a trip or route of a user. A user may log in and specify a starting location and a destination of a trip, for example, via a user interface. Localization module 301 communicates with other components of ADV 300, such as map and route data 311, to obtain the trip related data. For example, localization module 301 may obtain location and route data from a location server and a map and POI (MPOI) server. A location server provides location services and an MPOI server provides map services and the POIs of certain locations, which may be cached as part of map and route data 311. While ADV 300 is moving along the route, localization module 301 may also obtain real-time traffic information from a traffic information system or server.

Based on the sensor data provided by sensor system 115 and localization information obtained by localization module 301, a perception of the surrounding environment is determined by perception module 302. The perception information may represent what an ordinary driver would perceive surrounding a vehicle in which the driver is driving. The perception can include the lane configuration, traffic light signals, a relative position of another vehicle, a pedestrian, a building, crosswalk, or other traffic related signs (e.g., stop signs, yield signs), etc., for example, in a form of an object. The lane configuration includes information describing a lane or lanes, such as, for example, a shape of the lane (e.g., straight or curvature), a width of the lane, how many lanes in a road, one-way or two-way lane, merging or splitting lanes, exiting lane, etc.

Perception module 302 may include a computer vision system or functionalities of a computer vision system to process and analyze images captured by one or more cameras in order to identify objects and/or features in the environment of the ADV. The objects can include traffic signals, road way boundaries, other vehicles, pedestrians, and/or obstacles, etc. The computer vision system may use an object recognition algorithm, video tracking, and other computer vision techniques. In some embodiments, the computer vision system can map an environment, track objects, and estimate the speed of objects, etc. Perception module 302 can also detect objects based on other sensors data provided by other sensors such as a radar and/or LIDAR.

For each of the objects, prediction module 303 predicts what the object will behave under the circumstances. The prediction is performed based on the perception data perceiving the driving environment at the point in time in view of a set of map/route information 311 and traffic rules 312. For example, if the object is a vehicle at an opposing direction and the current driving environment includes an intersection, prediction module 303 will predict whether the vehicle will likely move straight forward or make a turn. If the perception data indicates that the intersection has no traffic light, prediction module 303 may predict that the vehicle may have to fully stop prior to enter the intersection. If the perception data indicates that the vehicle is currently at a left-turn only lane or a right-turn only lane, prediction module 303 may predict that the vehicle will more likely make a left turn or right turn respectively.

For each of the objects, decision module 304 makes a decision regarding how to handle the object. For example, for a particular object (e.g., another vehicle in a crossing route) as well as its metadata describing the object (e.g., a speed, direction, turning angle), decision module 304 decides how to encounter the object (e.g., overtake, yield, stop, pass). Decision module 304 may make such decisions according to a set of rules such as traffic rules or driving rules 312, which may be stored in persistent storage device 352.

Routing module 307 is configured to provide one or more routes or paths from a starting point to a destination point. For a given trip from a start location to a destination location, for example, received from a user, routing module 307 obtains route and map information 311 and determines all possible routes or paths from the starting location to reach the destination location. Routing module 307 may generate a reference line in a form of a topographic map for each of the routes it determines from the starting location to reach the destination location. A reference line refers to an ideal route or path without any interference from others such as other vehicles, obstacles, or traffic condition. That is, if there is no other vehicle, pedestrians, or obstacles on the road, an ADV should exactly or closely follows the reference line. The topographic maps are then provided to decision module 304 and/or planning module 305. Decision module 304 and/or planning module 305 examine all of the possible routes to select and modify one of the most optimal routes in view of other data provided by other modules such as traffic conditions from localization module 301, driving environment perceived by perception module 302, and traffic condition predicted by prediction module 303. The actual path or route for controlling the ADV may be close to or different from the reference line provided by routing module 307 dependent upon the specific driving environment at the point in time.

Based on a decision for each of the objects perceived, planning module 305 plans a path or route for the ADV, as well as driving parameters (e.g., distance, speed, and/or turning angle), using a reference line provided by routing module 307 as a basis. That is, for a given object, decision module 304 decides what to do with the object, while planning module 305 determines how to do it. For example, for a given object, decision module 304 may decide to pass the object, while planning module 305 may determine whether to pass on the left side or right side of the object. Planning and control data is generated by planning module 305 including information describing how vehicle 101 would move in a next moving cycle (e.g., next route/path segment). For example, the planning and control data may instruct vehicle 101 to move 10 meters at a speed of 30 miles per hour (mph), then change to a right lane at the speed of 25 mph.

Based on the planning and control data, control module 306 controls and drives the ADV, by sending proper commands or signals to vehicle control system 111, according to a route or path defined by the planning and control data. The planning and control data include sufficient information to drive the vehicle from a first point to a second point of a route or path using appropriate vehicle settings or driving parameters (e.g., throttle, braking, steering commands) at different points in time along the path or route.

In one embodiment, the planning phase is performed in a number of planning cycles, also referred to as driving cycles, such as, for example, in every time interval of 100 milliseconds (ms). For each of the planning cycles or driving cycles, one or more control commands will be issued based on the planning and control data. That is, for every 100 ms, planning module 305 plans a next route segment or path segment, for example, including a target position and the time required for the ADV to reach the target position. Alternatively, planning module 305 may further specify the specific speed, direction, and/or steering angle, etc. In one embodiment, planning module 305 plans a route segment or path segment for the next predetermined period of time such as 5 seconds. For each planning cycle, planning module 305 plans a target position for the current cycle (e.g., next 5 seconds) based on a target position planned in a previous cycle. Control module 306 then generates one or more control commands (e.g., throttle, brake, steering control commands) based on the planning and control data of the current cycle.

Note that decision module 304 and planning module 305 may be integrated as an integrated module. Decision module 304/planning module 305 may include a navigation system or functionalities of a navigation system to determine a driving path for the ADV. For example, the navigation system may determine a series of speeds and directional headings to affect movement of the ADV along a path that substantially avoids perceived obstacles while generally advancing the ADV along a roadway-based path leading to an ultimate destination. The destination may be set according to user inputs via user interface system 113. The navigation system may update the driving path dynamically while the ADV is in operation. The navigation system can incorporate data from a GPS system and one or more maps so as to determine the driving path for the ADV.

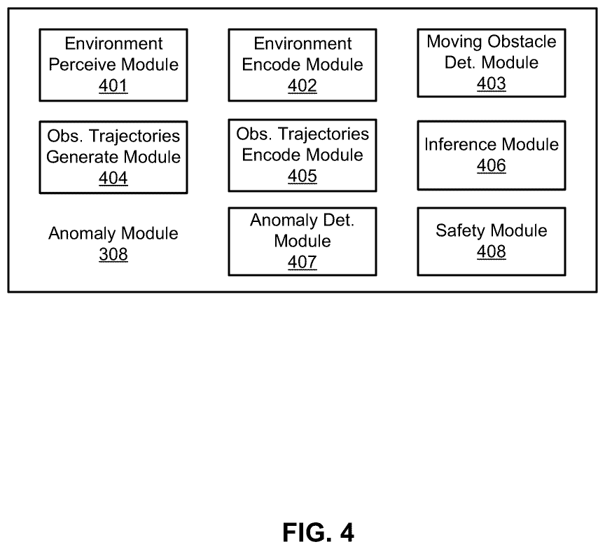

FIG. 4 is an example of anomaly module 308. Anomaly module 308 can identify a moving vehicle as anomalous from the perceived driving behavior of the moving vehicle. In one embodiment, anomaly module 308 includes environment perceive module 401, environment encode module 402, moving obstacle determine module 403, obstacle trajectory generate module 404, obstacle trajectory encode module 405, inference module 406, anomaly determine module 407, and safety module 408.

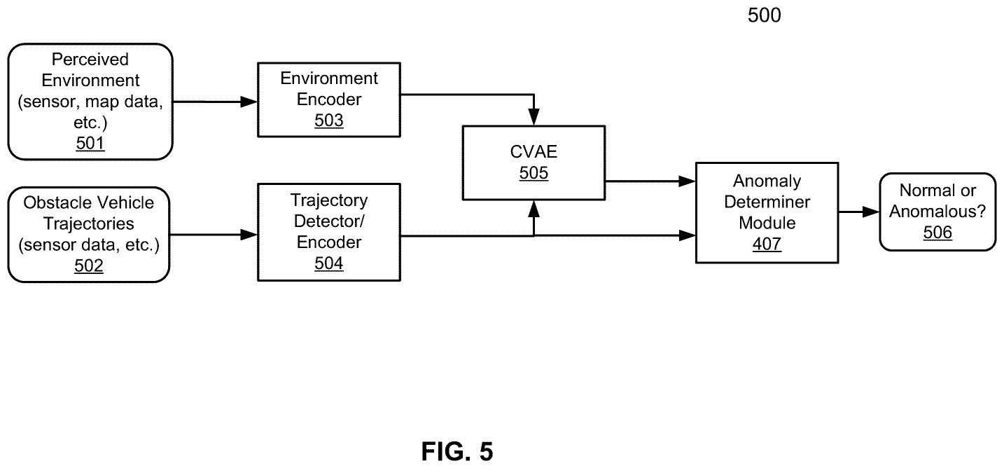

Environment perceive module 401 can perceive a driving environment of an ADV. The driving environment can be perceived using map data (such as map & route data 311 of FIG. 3A) and/or ADV mounted sensors, such as LIDAR, RADAR, and imaging sensors. Environment encode module 402 can encode the perceived environment into vector representations. The encoding reduces the amount of memory and processing used by the ADV downstream. Moving obstacle determine module 403 can identify neighboring moving obstacles (e.g., moving vehicles to the left, to the right, and in front of the ADV) via object detection or the like. Obstacle trajectory generate module 404 can generate a plurality of predictive trajectories for the moving obstacle. Similar to environment encode module 402, obstacle trajectory encode module 405 can encode the obstacle trajectories into vector representations. Inference module 406 can perform an inference to determine an anomalous moving obstacle (e.g., vehicle) using a neural network model. Anomaly determine module 407 can determine the performed inference generates a result that indicates the moving obstacle (vehicle) is anomalous. For identified anomalous vehicles, safety module 408 can update a safety margin or a distance threshold that the ADV uses to keep a safe distance from the anomalous vehicle. In some cases, safety module 408 can direct the ADV to plan a trajectory to overtake the anomalous vehicle. All or some of modules 401-408 can be implemented using a pipelined neural network model that includes two or more neural network models, as further described with respect to FIGS. 5-9.

The term vectorized representation or polyline refers to an image representation of a surrounding environment that geographic entities (e.g., lane lines, traffic lane, traffic light, stop sign, etc.) can be closely approximated as. A vector can be associated with a start point, an end point, semantic attributes indicating the type of objects represented by the vector (e.g., cross walk, lane line, traffic light, etc.), and any other identifying attributes, such as an identification (ID) of the vector. A polyline refers to a sequence of vectors. E.g., a lane line, traffic lane, driving trajectory can be represented by a polyline having a sequence of vectors. The polyline representation of map data and/or perceived moving obstacles (or moving agents) can be stored as a matrix, such as an adjacency matrix. A driving trajectory can also be represented by a polyline. A driving trajectory includes velocity and path information at each time step, e.g., location, and heading angle versus time, which can be captured by a polyline.

FIG. 5 is a block diagram illustrating an example of a pipelined neural network model 500 according to one embodiment. Pipelined neural network model 500 can be part of algorithms/models 124 of FIG. 3A. In one embodiment, pipelined neural network model 500 includes a conditional variational autoencoder (CVAE) 505. CVAE 505 is a variational autoencoder (VAE) that is conditioned on a deterministic constrained representation. The constraint can be set by a label and the label can force a deterministic output for any samples of the latent space representing the learned data). An autoencoder is an encoder-decoder architecture of neural networks used to learn efficient codings of unlabeled data (unsupervised learning). The encoding is validated and refined by attempting to regenerate the input from the encoding. A VAE is an autoencoder whose encoding distribution is regularised during the training in order to ensure that values in its latent space allow variations of new data to be generated. That is, instead of encoding an input as a single point, we encode it as a distribution over the latent space of the CVAE.

In one embodiment, CVAE 505 receives inputs from environment encoder 503 and trajectory encoder 504. Environment encoder 503 can encode an environment (map data, route data, and/or sensor data) perceived by the ADV into vector representations, each vector having semantic attributes and identifying attributes associated with the vector. Note that polyline and vector representation is used synonymously in this specification since polylines are groupings of one or more vectors.

Trajectory encoder 504 can encode a historical trajectory of the moving agent into polyline representations. For example, ADV can identify a moving agent (moving obstacle vehicles) that is neighboring or within a threshold distance to a left, right, or in front of the ADV. ADV then captures a historical trajectory of the moving agent (up to a current planning cycle). Trajectory encoder 504 can encode the historical trajectory into a polyline representation to be received by CVAE 505. CVAE 505 can receive the environment polyline information and the historical trajectory polyline information of the moving agent and generate a distribution of trajectories that is within the learnt distribution of the latent space of CVAE 505. Anomaly determiner module 407 can receive the distribution of trajectories from CVAE 505 and receives actual trajectory of the moving agent in subsequent planning cycles. Anomaly determiner module 407 can then compare the actual trajectory against the distribution of trajectories. If the receives actual trajectory is outside of the distribution of trajectories, the driving behavior of the agent is determined to be anomalous at 506. If the receives actual trajectory is within the distribution of trajectories, the driving behavior of the agent is normal at 506.

In one embodiment, when ADV determines that the moving agent is anomalous, ADV can indicate a visual or an audio signal to an operator of the ADV notifying the operator that a moving agent is anomalous. In another embodiment, when ADV determines that the moving agent is anomalous, ADV can increase a left/right safety distance threshold (e.g., 0.5 meter to 1.5 meters), and a front safety distance threshold (e.g., 5 meters to 10 meters) to the moving agent or plans a trajectory to surpass the moving agent.

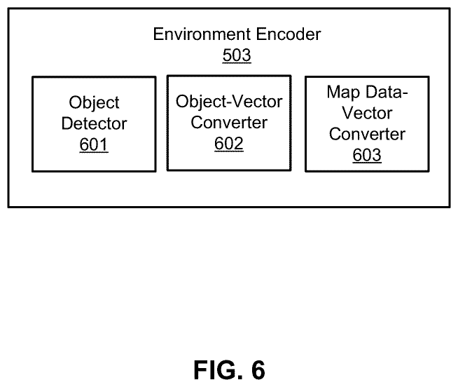

FIG. 6 is a block diagram illustrating an example of an environment encoder 503 according to one embodiment. Environment encoder 503 can encode a perceived environment and/or encode map/route data, such as map & route data 311 of FIG. 3A. For example, environment encoder 503 can include an objection detector 601, object-vector converter 602, and map data-vector converter 603. Objection detector 601 can be a convolutional neural network (CNN) or other machine learning models that detects and classifies objects perceived by the ADV through sensor data. The classified objects can be converted to a vector representation by objection-vector converter 602. The vectors can be associated with semantic attributes (indicators of the type of classified object, e.g., traffic light, vehicle, pedestrian, lane line, etc.), and identifiers that uniquely identify the vectors. Map data-vector converter 603 can convert the map data into vector representation.

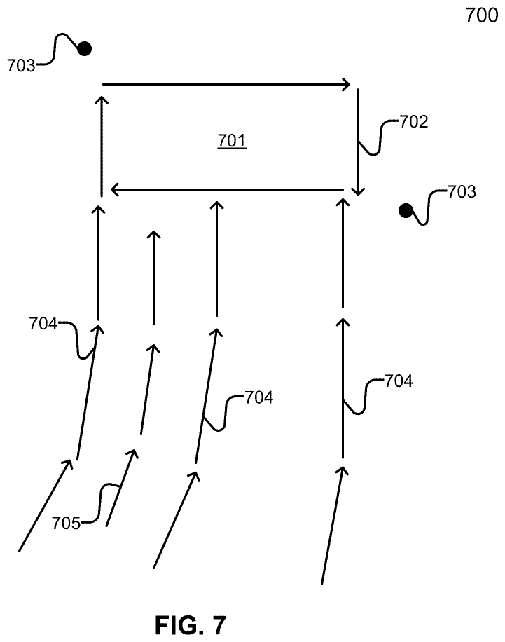

FIG. 7 is a block diagram illustrating an example of a perceived driving environment 700 in a vectorized representation according to one embodiment. Referring to FIG. 7, a cross walk 701 can be represent by four vectors 702, where attributes of vectors 702 indicate the vectors are attributed to a cross walk. Vectors 703 can be point vector (start point approximately equals to the end point) that represent stop signs. Vectors 704 can correspond to three polylines that represent the three lane lines. Vectors 705 can correspond to a polyline can represent a trajectory of a moving agent. The vectors for environment 700 can be stored as an adjacency matrix and a name-value pair for the vector attributes in adjacency matrix/attributes 125 of FIG. 3A. An adjacency matrix is a matrix describing node connections to adjacent neighboring nodes. The adjacency matrix and name-value pair of attributes can be an output of environment encoder 503.

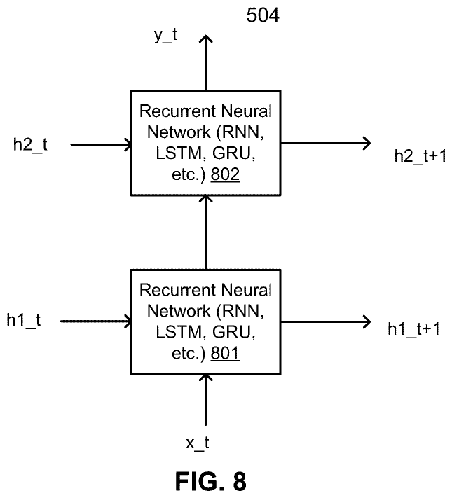

FIG. 8 is a block diagram illustrating an example of an obstacle trajectory encoder 504 according to one embodiment. Obstacle trajectory detector/encoder 504 can encode the trajectory information for a moving agent, and the encoded information can be used by a CVAE to generate a distribution of trajectories. Referring to FIG. 8, obstacle trajectory detector/encoder 504 can include a recurrent neural network (RNN), or a long short-term memory (LSTM) unit, or a gated recurrent unit (GRU) to capture time information of a trajectory of a moving agent In one embodiment, obstacle trajectory detector/encoder 504 includes a two-layer of RNNs, LSTMs, or GRUs 801-802 that is trained using historical trajectories. For example, referring to FIG. 8, a time-series trajectory data at time t can be the input at x_t. The hidden states at time t are h1_t and h2 t. The hidden states and the input trajectories are used to generate the output states y_t at time t. The output state y_t can be used by a CVAE as a starting point to generate the distribution of trajectories for the moving agent.

Here, the two-layer RNN/LSTM/GRUs are a deep recurrent learning structure that can extract path and temporal features of the trajectory, such as velocity, heading angle, change in velocity, a change in heading angle. Although a RNN is shown, other types of neural networks can be used for the encoder, such as a transformer-based neural network encoder or an attention-based neural network encoder.

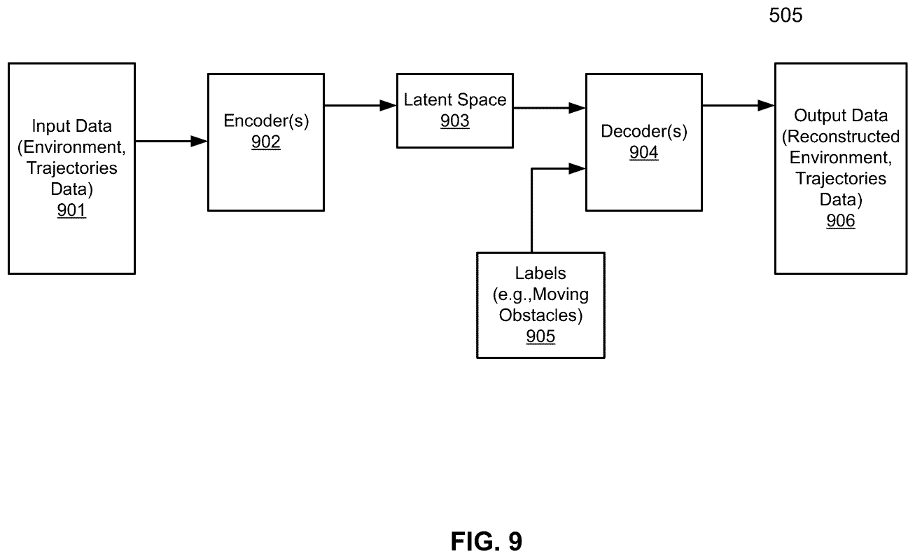

FIG. 9 is a block diagram illustrating an example of a conditional variational autoencoder (CVAE) 505 according to one embodiment. As previously described, CVAE can be trained, unsupervised, using historical driving data of the ADV. The trained CVAE can be used to generate new data varying a distribution of the latent space of the CVAE. In this case, CVAE 505 can be used to generate the distribution of trajectories of a moving agent by iterating through the distribution of the latent space of the CVAE. The distribution of trajectories can then be output as output data 906.

In one embodiment, CVAE 505 includes encoder(s) 902, latent space 903, decoder(s) 904, and labels 905. Encoder(s) 902 can receive the environment and historical trajectory of a moving agent as input data 901. In one embodiment, encoder(s) 902 can be combined with encoder environment encoder 503 and trajectory encoder 504 of FIG. 5. In one embodiment, encoder 902 includes an attention-based graph neural network (GNN). In one embodiment, the CVAE and GNN combination represents a conditional graph variational autoencoder. In one embodiment, the graph neural network can encode polylines representations of driving environments into a latent space 903, e.g., a low-dimensional representation. The latent space 903 can represent a distribution of inputs that the decoder should expect to see in a low-dimensional representation. In one embodiment, the latent space 903 is a two-dimensional space. In one embodiment, the latent space 903 is a multi-dimension Gaussian distribution represented by a vector of mean and a vector of standard deviation values. In one embodiment, the distribution latent space can be sampled to obtain a distribution of trajectories. Complementary decoder(s) 904 can decode the sampled latent space and generate new trajectory data (e.g., distribution of trajectories for the moving agent with non-anomalous behaviors). Here, decoder(s) 904 can be complementary to the encoder(s) 902. For example, if encoder 902 includes a GNN, decoder 904 can include a GNN. If the encoder 902 includes two-layer of GRUs, decoder 904 can correspondingly include two-layer of GRUs.

Note that the goal of encoder 902 is to translate the features of an environment and trajectory into a low-dimensional representation. Decoder 904 inputs variations of the low-dimensional representation, a label 905 constraining the object to a particular type (e.g., moving obstacle), and decoder 904 reconstructs variations of the original data that the decoder 904 has previously trained to anticipate. Here, the encoder-decoder architecture of CVAE 505 is trained to minimize information loss when decoder 904 reconstructs variations of the original data.

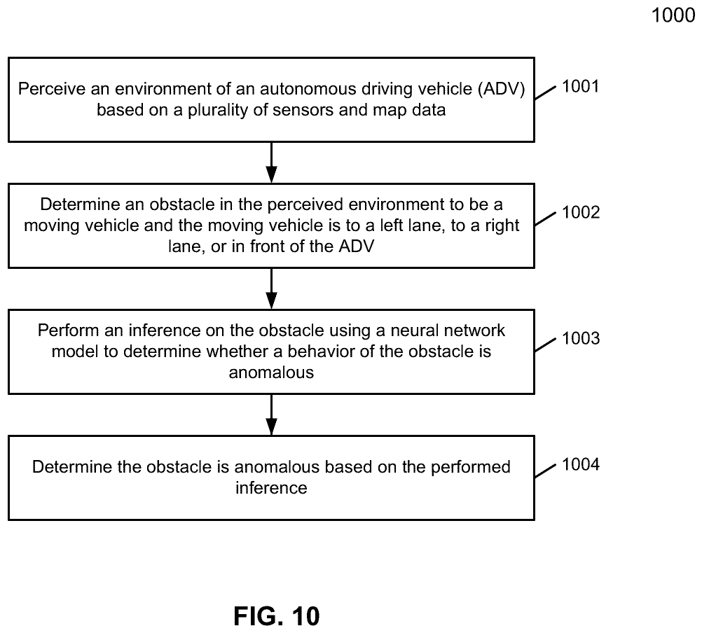

FIG. 10 is a flow diagram illustrating a method to identify anomalous moving agents according to one embodiment. Process 1000 may be performed by processing logic which may include software, hardware, or a combination thereof. For example, process 1000 may be performed by anomaly module 308 of FIG. 4.

At block 1001, processing logic perceives an environment of an autonomous driving vehicle (ADV) based on a plurality of sensors and map data.

At block 1002, processing logic determines an obstacle in the perceived environment to be a moving vehicle and the moving vehicle is to a left lane, to a right lane, or in front of the ADV. The moving obstacle can be perceived using image detection algorithms, CNN, or other types of machine learning models.

At block 1003, processing logic performs an inference on the obstacle using a neural network model to determine whether a behavior of the obstacle is anomalous.

For example, the pipelined neural network model 500 of FIG. 5 is used to perform an inference capturing a trajectory of the obstacle. The inference generates a distribution of trajectories.

At block 1004, processing logic determines the obstacle is anomalous based on the performed inference.

For example, at subsequent planning cycles, processing logic compares the distribution of trajectories with an actual trajectory of the moving obstacle and determines if the actual trajectory is within the anticipated distribution of trajectories.

In one embodiment, the neural network model includes a pipeline of two or more neural network models. E.g., CNN for object detection, coupled to a two-layer GRUs neural network, which is coupled to a CVAE, as shown in model 500 of FIG. 5.

In one embodiment, the neural network model includes a conditional variational autoencoder (CVAE) that detects anomalous behaviors of moving obstacles.

In one embodiment, the CVAE includes an environment encoder and an environment decoder, wherein the environment encoder or environment decoder includes a graph neural network model to encode or decode the perceived environment into polylines.

In one embodiment, the CVAE includes an obstacle trajectory encoder and an obstacle trajectory decoder, wherein the obstacle trajectory encoder or obstacle trajectory decoder includes a deep neural network model to encode a historical trajectory of the obstacle.

In one embodiment, the historical trajectory of the obstacle includes velocity and positional information of the obstacle for a plurality of planning cycles.

In one embodiment, the deep neural network model of the obstacle trajectory decoder includes two layers of gated recurrent units (GRUs), or two layers of long short-term memory (LSTMs) units, or two layers of recurrent neural networks (RNNs).

In one embodiment, a latent space of the CVAE corresponds to a distribution of trajectories.

In one embodiment, in response to identifying the obstacle is anomalous based on the performed inference, processing logic further increases a safety buffer distance from the obstacle or surpasses the obstacle.

Note that some or all of the components as shown and described above may be implemented in software, hardware, or a combination thereof. For example, such components can be implemented as software installed and stored in a persistent storage device, which can be loaded and executed in a memory by a processor (not shown) to carry out the processes or operations described throughout this application. Alternatively, such components can be implemented as executable code programmed or embedded into dedicated hardware such as an integrated circuit (e.g., an application specific IC or ASIC), a digital signal processor (DSP), or a field programmable gate array (FPGA), which can be accessed via a corresponding driver and/or operating system from an application. Furthermore, such components can be implemented as specific hardware logic in a processor or processor core as part of an instruction set accessible by a software component via one or more specific instructions.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the disclosure also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present disclosure are not described with reference to any particular programming language. It will be appreciated that a variety of programming languages may be used to implement the teachings of embodiments of the disclosure as described herein.

In the foregoing specification, embodiments of the disclosure have been described with reference to specific exemplary embodiments thereof. It will be evident that various modifications may be made thereto without departing from the broader spirit and scope of the disclosure as set forth in the following claims. The specification and drawings are, accordingly, to be regarded in an illustrative sense rather than a restrictive sense.

What is claimed is:

1. A computer-implemented method, comprising:
perceiving an environment of an autonomous driving vehicle (ADV) based on a plurality of sensors and map data;
determining an obstacle in the perceived environment to be a moving vehicle and the moving vehicle is to a left lane, to a right lane, or in front of the ADV;
performing an inference on the obstacle using a neural network model to determine whether a behavior of the obstacle is anomalous; and
determining the obstacle is anomalous based on the performed inference.

2. The method of claim 1, wherein the neural network model includes a pipeline of two or more neural network models.

3. The method of claim 1, wherein the neural network model includes a conditional variational autoencoder (CVAE) that detects anomalous behaviors of moving obstacles.

4. The method of claim 3, wherein the CVAE includes an environment encoder and an environment decoder, wherein the environment encoder or environment decoder includes a graph neural network model to encode or decode the perceived environment into polylines.

5. The method of claim 3, wherein the CVAE includes an obstacle trajectory encoder and an obstacle trajectory decoder, wherein the obstacle trajectory encoder or obstacle trajectory decoder includes a deep neural network model to encode a historical trajectory of the obstacle.

6. The method of claim 5, wherein the historical trajectory of the obstacle includes velocity and positional information of the obstacle for a plurality of planning cycles.

7. The method of claim 5, wherein the deep neural network model of the obstacle trajectory decoder includes two layers of gated recurrent units (GRUs), or two layers of long short-term memory (LSTMs) units, or two layers of recurrent neural networks (RNNs).

8. The method of claim 7, wherein a latent space of the CVAE corresponds to a distribution of trajectories.

9. The method of claim 1, further comprising:
in response to identifying the obstacle is anomalous based on the performed inference, increasing a safety buffer distance from the obstacle or surpassing the obstacle.

10. A non-transitory machine-readable medium having instructions stored therein, which when executed by a processor, cause the processor to perform operations, the operations comprising:
perceiving an environment of an autonomous driving vehicle (ADV) based on a plurality of sensors and map data;
determining an obstacle in the perceived environment to be a moving vehicle and the moving vehicle is to a left lane, to a right lane, or in front of the ADV;
performing an inference on the obstacle using a neural network model to determine whether a behavior of the obstacle is anomalous; and
determining the obstacle is anomalous based on the performed inference.

11. The non-transitory machine-readable medium of claim 10, wherein the neural network model includes a pipeline of two or more neural network models.

12. The non-transitory machine-readable medium of claim 10, wherein the neural network model includes a conditional variational autoencoder (CVAE) that detects anomalous behaviors of moving obstacles.

13. The non-transitory machine-readable medium of claim 12, wherein the CVAE includes an environment encoder and an environment decoder, wherein the environment encoder or environment decoder includes a graph neural network model to encode or decode the perceived environment into polylines.

14. The non-transitory machine-readable medium of claim 12, wherein the CVAE includes an obstacle trajectory encoder and an obstacle trajectory decoder, wherein the obstacle trajectory encoder or obstacle trajectory decoder includes a deep neural network model to encode a historical trajectory of the obstacle.

15. The non-transitory machine-readable medium of claim 14, wherein the historical trajectory of the obstacle includes velocity and positional information of the obstacle for a plurality of planning cycles.

16. The method of claim 5, wherein the deep neural network model of the obstacle trajectory decoder includes two layers of gated recurrent units (GRUs), or two layers of long short-term memory (LSTMs) units, or two layers of recurrent neural networks (RNNs).

17. The non-transitory machine-readable medium of claim 16, wherein a latent space of the CVAE corresponds to a distribution of trajectories.

18. The non-transitory machine-readable medium of claim 10, wherein the operators further comprise:
in response to identifying the obstacle is anomalous based on the performed inference, increasing a safety buffer distance from the obstacle or surpassing the obstacle.

19. A data processing system, comprising:
a processor; and
a memory coupled to the processor to store instructions, which when executed by the processor, cause the processor to perform operations, the operations including
perceiving an environment of an autonomous driving vehicle (ADV) based on a plurality of sensors and map data;
determining an obstacle in the perceived environment to be a moving vehicle and the moving vehicle is to a left lane, to a right lane, or in front of the ADV;
performing an inference on the obstacle using a neural network model to determine whether a behavior of the obstacle is anomalous; and
determining the obstacle is anomalous based on the performed inference.

20. The system of claim 19, wherein the neural network model includes a pipeline of two or more neural network models.
